(19) United States
(12) Patent Application Publication
(10) Pub. No.: US 2009/0024674 A1
(43) Pub. Date: Jan. 22, 2009

(54) AUTOMATIC FILE VERSIONING

(75) Inventor: Warren GALLAGHER, Richmond (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: GRIDIRON SOFTWARE INC., Ottawa (CA)

(21) Appl. No.: 12/175,238

(22) Filed: Jul. 17, 2008

Related U.S. Application Data
(60) Provisional application No. 60/950,155, filed on Jul. 17, 2007.
(60) Provisional application No. 60/950,166, filed on Jul. 17, 2007.
(60) Provisional application No. 60/950,158, filed on Jul. 17, 2007.
(60) Provisional application No. 60/950,159, filed on Jul. 17, 2007.

(51) Int. Cl. G06F 17/30

(52) U.S. Cl. 707/203; 707/E17.005

(57) ABSTRACT

A method and system are provided to automatically and transparently version files across many desktop applications without requiring the user to take specific action to cause the versioning to occur. Previous versions and versioning information can both be stored using hard links, and the versioning information can be used to determine a version history for a file. Embodiments of the present invention do not require applications to be modified to support this versioning method. Further, using one approach, the application does not even know that the versioning is occurring. The present invention provides an automatic versioning solution that is completely transparent to the user, which causes overwrite operations to be seamlessly co-opted into versioning operations which retain previous document versions instead of overwriting them.

### CROSS REFERENCE TO RELATED APPLICATIONS

This application claims the benefit of priority of U.S. Provisional Patent Application No. 60/950,155 filed Jul. 17, 2007, which is incorporated herein by reference in its entirety.

This application is related to the following applications: U.S. Provisional Patent Application No. 60/950,166 filed on Jul. 17, 2007 and entitled “File Browser For Computing Environment”; U.S. Provisional Patent Application No. 60/950,158 filed on Jul. 17, 2007 and entitled “Indexing Through File Format Understanding”; U.S. Provisional Patent Application No. 60/950,159 filed on Jul. 17, 2007 and entitled “Method and Apparatus for Workflow Versioning”; U.S. application Ser. No. ______ (Attorney Docket No.: PAT 4299-2) entitled “Automatic Workflow Versioning” and filed of even date herewith; and U.S. application Ser. No. ______ (Attorney Docket No.: PAT 4297-2) entitled “Asset Browser for Computing Environment” and filed of even date herewith.

### FIELD OF THE INVENTION

The present invention relates generally to computing environments. More particularly, the present invention relates to desktop computing environments able to retain multiple versions of files.

### BACKGROUND OF THE INVENTION

Computing environments, such as desktop computing environments, enable users to create and modify documents. When saving revisions to their documents, users are faced with two options: overwrite the previous version of their document, or save a new version of it. When overwriting files instead of creating new versions, applications create updated versions of original files which briefly co-exist with the original files prior to overwriting them. When saving new copies of their documents, users can manually save new copies of their files using naming conventions that provide them with information about the relationship of the new copy to its previous version(s), but this is a time consuming process and is subject to the vagaries of human error and creativity. Such a manual versioning approach can lead to a scattered proliferation of backups and versions that cannot be meaningfully associated with each other by users other than their creator, and sometimes even their creator forgets the naming convention over time.

In view of the inherent disadvantages of manual versioning, programs have been developed which provide an automatic versioning capability by maintaining revision information within a document file whenever it is saved, which is effectively a hybrid operation somewhere between overwriting the file and saving a new copy. Other automatic versioning programs provide an automatic versioning capability which causes documents to be saved as new files whose names follow a predictable and user-independent pattern, but these programs require user involvement in the sense that the user must actively choose to use them rather than simply overwriting their document each time they change it. Still other automatic versioning programs provide a facility to “check out” a document version to work on and a “check-in” facility that allows a new version to be saved according to some naming convention, but these programs require user intervention as well.

All of the above mentioned techniques either require the user to take explicit action to cause versioning to occur, require extra steps (such as checking files in and out), or inflate the size of the document on disk by retaining large quantities of revision information, rendering the document increasingly cumbersome to work with in terms of random access memory requirements. Further, none of these mechanisms provide automatic, seamless file versioning that works uniformly across desktop applications.

A fundamental capability is missing from today's desktop computing environments. That is the ability to automatically retain multiple versions of files created by standard applications such as word processors, spreadsheets, drawing tools and graphics tools without requiring user intervention or unnecessarily inflating file sizes. It is therefore desirable to provide an improved automatic file versioning system.

### SUMMARY OF THE INVENTION

It is an object of the present invention to obviate or mitigate at least one disadvantage of previous file versioning approaches.

The present invention provides an automatic versioning solution that is completely transparent to the user, which causes overwrite operations to be seamlessly co-opted into versioning operations which retain previous document versions instead of overwriting them.

In an aspect, the present invention provides a method of automatic file versioning in a computing environment. The method includes detecting the initiation of a file system event wherein an updated version of an original file stored at an original storage location is written to a new storage location, identifying the file system event as a first component of a file versioning event; and creating a hard link to the original storage location. The hard link indicates a version relationship between the original file and the updated version, and it is created prior to the occurrence of a final component of the file versioning event wherein an original file storage location identifier is scheduled to be disassociated from the original storage location.

In an embodiment, the hard link includes a hard link storage location identifier derived from an updated file storage location identifier associated with the updated file. The hard link storage location identifier indicates the version relationship between the original file and the updated version. In another embodiment, the hard link storage location identifier is a hard link directory path and file name derived from a directory path and file name associated with the updated file.

In an embodiment, the detecting, identifying and creating steps are performed transparently without input from a user. In another embodiment, these steps are performed as background processes in the computing environment. In yet another embodiment, these steps are application-independent having regard to an application associated with the file system event. In yet another embodiment, these steps are file-format independent having regard to a file format associated with the file system event.

In another aspect, the present invention provides a system for automatic file versioning in a computing environment including a file system event monitor and a file versioner. The file system event monitor is in communication with a file system events engine, and serves to detect the initiation of file system events wherein an updated version of an original file stored at an original storage location is written to a new storage location. The file system event monitor also serves to identify file system events as first components of file versioning events. The file versioner is in communication with the file system event monitor, and serves to create a hard link to the original storage location upon receipt of a communication from the file system event monitor indicating that the first component of a file versioning event has been identified. The hard link created by the file versioner indicates a version relationship between the original file and the updated version, and it is created prior to the occurrence of a final component of the file versioning event wherein an original storage location identifier is scheduled to be disassociated from a file system location for the original file.

In an embodiment, the hard link created by the file versioner derives a hard link storage location identifier from an updated file storage location identifier associated with the updated file. The hard link storage location identifier indicates the version relationship between the original file and the updated version. In another embodiment, the hard link storage location identifier is a hard link directory path and file name derived from a directory path and file name associated with the updated file.

In an embodiment, the file system event monitor and file versioner operate transparently without input from a user. In another embodiment, the file system event monitor and file versioner operate as background processes in the computing environment. In yet another embodiment, the operation of the file system event monitor and file versioner is application-independent having regard to an application associated with the file system event. In yet another embodiment, these steps can be file-format independent having regard to a file format associated with the file system event.

In an embodiment, the system of the present invention includes a user preferences module for restricting the operation of the file versioner according to stored file versioning preferences.

In another aspect, the present invention provides a computer readable medium containing computer instructions which, when executed, cause a processor to perform a method of automatic file versioning. The instructions include instructions for detecting initiation of a file system event wherein an updated version of an original file stored at an original storage location is written to a new storage location, instructions for identifying the file system event as a first component of a file versioning event; and instructions for creating a hard link to the original storage location. The instructions for creating the hard link hard link ensure that the hard link indicates a version relationship between the original file and the updated version, and is created prior to the occurrence of a final component of the file versioning event wherein an original file storage location identifier is scheduled to be disassociated from the original storage location.

In an embodiment, the computer readable medium includes instructions ensuring that the hard link includes a hard link storage location identifier derived from an updated file storage location identifier associated with the updated file. The hard link storage location identifier indicates the version relationship between the original file and the updated version. In another embodiment, the computer readable medium includes instructions ensuring that the hard link storage location identifier is a hard link directory path and file name derived from a directory path and file name associated with the updated file.

In an embodiment, the computer readable medium includes instructions ensuring that, when the instructions for detecting, identifying and creating are executed, they are executed transparently without input from a user. In another embodiment, the computer readable medium includes instructions ensuring that the instructions for detecting, identifying and creating are executed, they are executed as background processes in the computing environment. In yet another embodiment, the computer readable medium includes instructions for detecting, identifying and creating that are application-independent having regard to an application associated with the file system event. In yet another embodiment, the computer readable medium includes instructions for detecting, identifying and creating that are file-format independent having regard to a file format associated with the file system event.

In yet another aspect, the present invention provides a method of automatic file versioning in a computing environment including detecting initiation by an application of a file system event in a file system wherein an updated version of an original file stored at an original storage location is written to a new storage location, identifying the file system event as a first component of a file versioning event, and, if the application can hard link and if the file system can hard link, creating a hard link to the original storage location. The hard link indicates a version relationship between the original file and the updated version, and is created prior to the occurrence of a final component of the file versioning event wherein the original storage location is scheduled to be disassociated from a file system location for the original file. In the case where the file system is a remote file system and either one of the application and the file system cannot hard link, the method creates a server-side copy of the file. In the case where the file system is a local file system and either the application cannot hard link or the file system cannot hard link, the method creates a local copy of the file.

In a still further aspect, the present invention provides a method automatic file versioning in a computing environment. The method includes detecting initiation of a file system event wherein an updated version of an original file stored at an original storage location is written to a new storage location, identifying the file system event as a first component of a file versioning event, and causing a new file storage location identifier to become associated with the original storage location. The new file storage location identifier indicates a version relationship between the original file and the updated version, and prevents the file system from de-allocating the original storage location. The step of causing a new file storage location identifier to become associated with the original storage location occurs prior to occurrence of a final component of the file versioning event wherein an original file storage location identifier is scheduled to be disassociated from the original storage location.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a flowchart illustrating a known “write a temporary file” method of overwriting a file;

FIGS. 2-4 illustrate the state of a file system prior to, during, and after the execution of a known “write a temporary file” method of overwriting a file;

FIG. 5 is a flowchart illustrating a known “delete/write file” method of overwriting a file;

FIGS. 6-8 illustrate the state of a file system prior to, during, and after the execution of a known “delete/write file” method of overwriting a file;

FIG. 9 is a block diagram of a system for automatic file versioning according to an embodiment of the present invention;

FIG. 10 is a flowchart illustrating a method of automatic file versioning according to an embodiment of the invention;

FIGS. 11-17 illustrate the state of an exemplary file system and operating system at different points in the execution of a method of automatic file versioning according to an embodiment of the present invention; and

FIG. 18 is a flowchart illustrating a method of automatic file versioning according to an embodiment of the invention, the method being compatible with various types of applications and file system locations.

### DETAILED DESCRIPTION

Generally, the present invention provides a method and system to automatically and transparently version files across many desktop applications without requiring a user to take specific action to cause the versioning to occur. Further, the user can have the capability to browse saved versions and recall a previous version of a file. Embodiments of the present invention do not require applications to be modified to support this versioning method. Further, using one approach, the application does not even know that the versioning is occurring. The present invention provides an automatic versioning solution that is completely transparent to the user, which causes overwrite operations to be seamlessly co-opted into versioning operations which retain previous document versions instead of overwriting them.

A fundamental premise of embodiments of the present invention is that by observing how applications interact with the file system when saving documents, it is possible to transparently prevent the application from deleting old document versions while not interfering with the application's ability to write out changes to a document file. This is accomplished by creating a hard link to the original file's original storage location prior to the its disassociation from the file storage location identifier for the original file, as would be the case in the prior art methods described above.

As is well known in the art, a hard link is generally a type of file system entity which appears to be a file, but in reality comprises a combination of a file system storage location identifier such as a file name and path, and a pointer to a storage location for a file with which the hard link is associated. Of course, it should be appreciated that the concept of a hard link can be extended in embodiments of the present invention to include additional information besides a file system storage location identifier and a pointer to a storage location for a file.

To enable triggering of automatic versioning it is important to know when an application is writing a document file to the file system. Fortunately, modern operating systems such as Linux, Microsoft Windows and Apple OS X allow the creation of operating system kernel extensions that can provide information such as: whether a file operation is occurring, the user id associated with a file system operation, the application process associated with a file system operation request, the nature of a file system operation, and the file path(s) the operation is being performed on. For example, such a kernel extension is a standard feature of the Mac OS X Leopard® operating system. For convenience, such a kernel extension will be referred to herein as a file system events engine. Typical file system events which applications in a user space can receive notification of from a file system events engine are: a file open operation, a file close unmodified operation, a file close modified operation, a file delete operation, a file rename operation and a file link operation.

The alternative to versioning a document is overwriting it. Although, to a user, the act of overwriting a file appears to simply consist of saving a new copy of a file over top of the old one, most applications do not actually overwrite existing document files when the user requests a save operation, i.e. they do not actually write data to the same physical storage area as the original file. The reason for this is that if any steps in saving the document fail, the application should be able, at a minimum, to maintain the integrity of the original file.

File allocation systems typically employ the user-friendly concepts of “path” and “filename” to represent a set of nested directories within which a file having a given file name is said to be “located”. These paths and filenames are actually a series of labels for nodes (which may or may not have their own separate existence within the file system) that make up a notional user-friendly hierarchical file organization scheme. As used herein, the various nested directories and file names that ultimately provide a user-space location for a file will be referred to as a “file storage location identifier” associated with that file. The term “file storage location identifier” is used in the sense that, although the file is physically located at a physical storage location on storage media, the user is presented with a notional file organization scheme which presents the file as being located at a location within some combination of nested directories and/or file names which makes up the file storage location identifier.

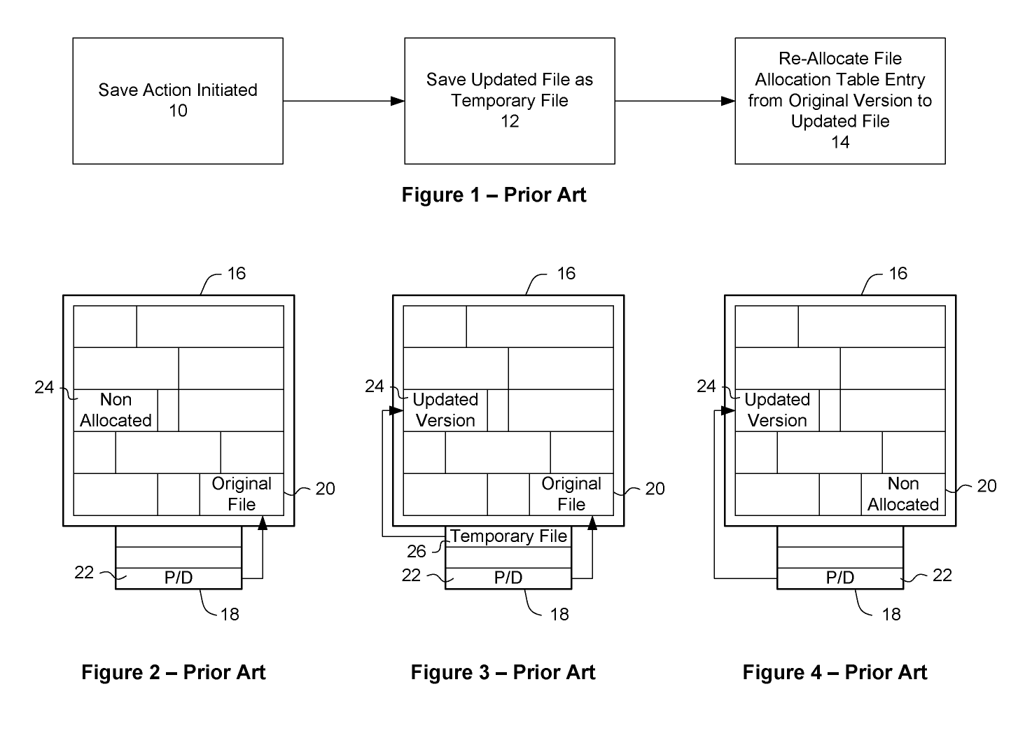

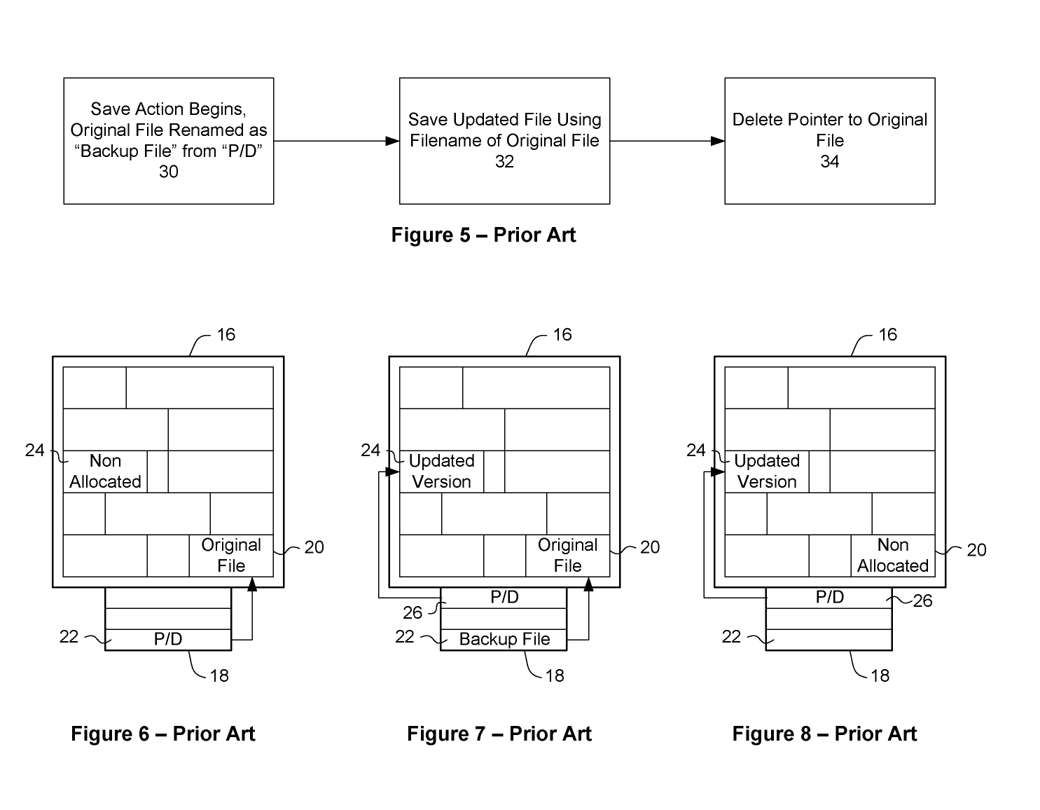

In view of the fact that most file systems have a file allocation system that relates each file's storage location identifier to its storage location, most applications have been designed to save files to disk according to one of two methods when overwriting a previous version of a file with a new version of the same file, each of which depends on altering the information about a file's location that is stored in the file allocation system. Applications typically behave in one of two ways when they are overwriting a file as a result of a “save” operation: 1) the “write a temporary file” method, an exemplary embodiment of which is illustrated in FIGS. 1-4; and 2) the “delete/write file” method, an exemplary embodiment of which is illustrated in FIGS. 5-8.

FIG. 1 is an illustration of a known “write a temporary file” method of overwriting a file. In the method of FIG. 1, a save action is initiated at step 10. After step 10, the method proceeds to step 12 where an updated version of an original file is saved as a temporary file. Finally, after step 12, the method proceeds to step 14 where the file allocation table entry for the original file is reallocated to the updated file.

FIGS. 2-4 are illustrations of the state of a file system prior to, during, and after the execution of the known “write a temporary file” method of overwriting a file. As shown in FIG. 2, the storage medium 16 comprises a number of clusters of memory that have been variously allocated, in a file allocation table 18, to different files. The storage medium 16 includes an original file stored at a first storage location 20. The first storage location 20 is associated with a first file storage location identifier 22. In this example, the file storage location identifier for the original file is “P/D”, where P can be any arbitrary path, including a set of nested directories and subdirectories, and D can be any filename. A second storage location 24 is non-allocated in FIG. 2.

In FIGS. 3-4, the second storage location 24 stores an updated version of the original file and is associated with a second file storage location identifier 26. In FIG. 3, the file storage location identifier for second file allocation table is “Temporary File”.

In FIG. 4, the first file storage location identifier 22 is associated with the second storage location 24 by changing its association with the first storage location 20 to an association with the second storage location 24. This renders the first storage location 20 that was formerly allocated to the original version of the file “non allocated”, effectively deleting it. This de-allocation of storage space can be described as disassociating the first file storage location identifier 22 from the first storage location 20.

FIG. 5 is an illustration of a known “delete/write file” method of overwriting a file. In the method of FIG. 5, a save action is initiated at step 30 by renaming an original file as a backup file. After step 30, the method proceeds to step 32 where an updated version of an original file is saved using the filename of the original file. Finally, after step 32, the method proceeds to step 34 where the file allocation table entry for the backup file is disassociated from the storage location of the original file.

FIGS. 6-8 are illustrations of the state of a file system prior to, during, and after the execution of the known “delete/write file” method of overwriting a file. The storage medium comprises elements similar to those identified in FIGS. 2-4, with FIG. 6 being identical to FIG. 2.

In FIG. 7 the first file storage location identifier 22 is changed to “Backup File”. The second file storage location identifier 26 is associated with the second storage location 24 where the updated version of the original file is written to the storage medium 16. However, unlike the “write a temporary file” method of FIGS. 1-4, here the second file storage location identifier 26 is made the same as the first file storage location identifier 22 of FIG. 6, namely “P/D”

In FIG. 8, the first file storage location identifier 22 has been removed from the file allocation table 18. The file storage location identifier “P/D” is now assigned to the second file storage location identifier 22, which is associated with the updated version of the original file at second storage location 24. Because file allocation table entry 22 has been deleted from file allocation table 18, it has been disassociated from the first storage location 20 that was formerly allocated to the original version of the file, rendering the first storage location 20 “non allocated”.

Having regard to the foregoing, it should be noted that there is a point during the aforementioned known methods of overwriting a file at which the file system not only has copies of both the previous version and the new version of the file being overwritten, but it also has information about their storage location on the storage medium. This point occurs between steps 12 and 14 of FIG. 1 in the “Write a Temporary File” method and between steps 30 and 32 of FIG. 5 in the “Delete/Write File” method. However, no known automatic file versioning system takes advantage of the opportunity presented by this set of circumstances. One reason for this is the difficulty of salvaging the original file before its associated physical storage location is disassociated from its file storage location identifier.

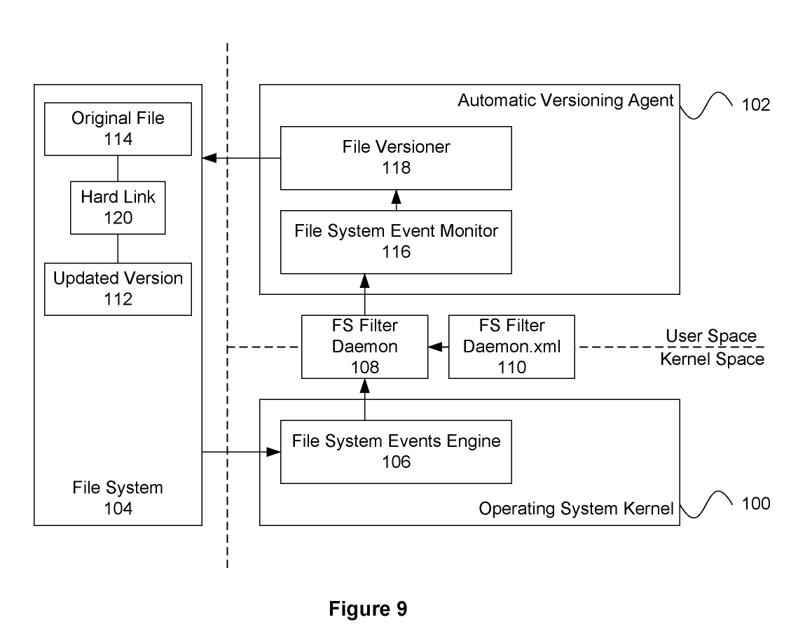

FIG. 9 is a block diagram of a system for automatic file versioning according to an embodiment of the present invention. Embodiments of the present invention utilize a file system events engine that notifies a user-space versioner program of file system events. The user space program receives these notifications from kernel space and reacts to certain events to perform transparent file versioning.

The exemplary system of illustrated in FIG. 9 is divided by a dashed line into a user space and a kernel space. This distinction between user space and kernel space is notional, since all software is ultimately executed by the operating system. For the purposes of the present illustration, the distinction serves to clarify the separation of those components of the system which are integrated into an operating system kernel 100 (and, in certain cases, such as the Mac OS X Leopard® operating system, pre-existing therein) from those components of the system which are outside the operating system kernel, such as an automatic versioning agent 102, which resides in user space. A file system 104 exists separate from both the user space and kernel space, although it is accessible to system elements residing within either space.

As illustrated in FIG. 9, the file system 104 is in communication with the operating system kernel 100 via at least a file system events engine 106, which can be a type of kernel extension, or can be an integral part of the operating system kernel 100. The file system events engine 106 is in communication with a file system (FS) filter daemon 108, which filters file system events received from the file system events engine 106 according to a filtering scheme, which can be stored in a “FS Filter Daemon.xml” file 110. The FS filter daemon 108 and FS Filter Daemon.xls file 110 are depicted straddling the line between user space and kernel space since Daemons are typically background processes which do not exclusively belong to either space, albeit accessible by both. The FS filter Daemon 108 differentiates file system events, such as the file versioning events mentioned above, which are components of larger events that can be referred to as file versioning events, for convenience.

As previously mentioned, a file versioning event is any sequence of component file system events which result in the creation of an updated version 112 of an original file 114. A file versioning event involves at least one file system event wherein an updated version 112 of an original file 114 stored at an original storage location is written to a new storage location. The FS filter daemon 108 communicates file system events, which can be components of file versioning events, to a file system event monitor 116 component of the automatic versioning agent 102. The file system event monitor 116 is a listening/monitoring entity that communicates with a file versioner 118 when it identifies a file system event from the FS filter daemon 116 that is a first component of a file versioning event. It is the role of the file system event monitor 116 to determine that this first component in fact indicates that a file versioning event has begun, thus identifying that an updated version 112 of original file 114 is being created.

When the file versioner 118 receives a communication from the file system event monitor 116 indicating that an updated version 112 of original file 114 is being created, the file versioner 118 causes a hard link 120 to be created within file system 104 which indicates a version relationship between the original file 114 and its updated version 112. Accordingly, when an application attempts to overwrite original file 114 by saving a new copy elsewhere on file system 104, a hard link 120 is nevertheless created to original file 114 that persists beyond any disassociation of the original file from its original file system location identifier. This is done even though the application may eventually delete the entry in the file allocation catalog of file system 104 (or its b*tree entry, or inode pointer, or other allocation relationship, as the case may be) by attempting to disassociate the original file storage location identifier for original file 114 from its original storage location within the file system.

In certain embodiments, the system can include a user preferences module (not shown) for restricting the operation of the file versioner according to stored file versioning preferences. These file versioning preferences can include, for example: how many versions of a file to keep; the-time span during which file versions should be kept; and/or the amount of storage space to allow for storing file versions. These options can be made available to a user or a system administrator to permit customization based on different needs.

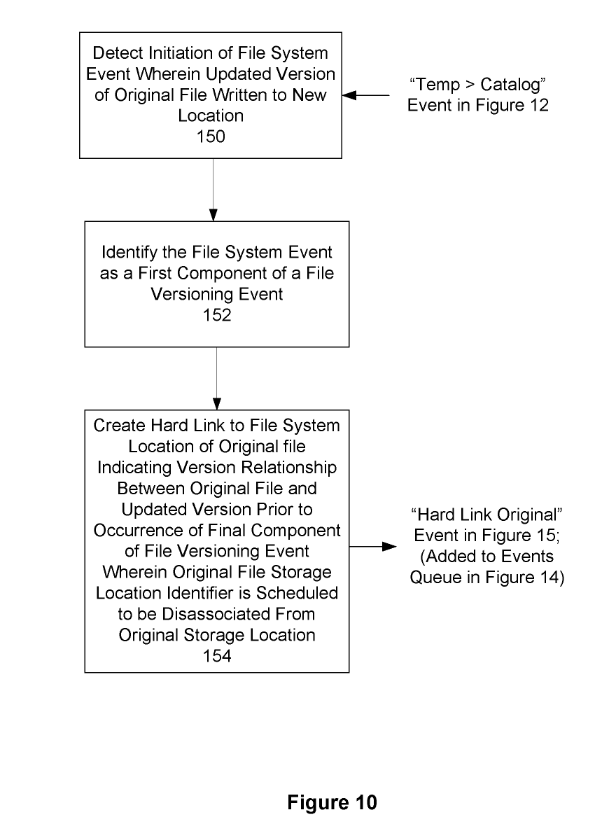

FIG. 10 is an illustration of a method of automatic file versioning according to an embodiment of the invention. By combining file system monitoring, hard linking and knowledge of how applications save document files, the exemplary method of FIG. 10 can implement automatic versioning. The method of FIG. 10 begins at step 150, where a file versioning component event is detected. This is a type of file system event that indicates that the creation of a temporary file for storing contents of an updated version of an original file is being initiated. Accordingly, the automatic versioning method of the present invention proceeds to identify the file system event as a first component of a file versioning event at step 152, following step 150. The automatic versioning method then proceeds at step 154 to create a hard link to the original file prior to the execution of a final component of the file versioning event. In the final component, the filename for the original file is scheduled to be disassociated from the original storage location of the original file.

One example of how the method of FIG. 10 can be performed is as follows. An application may attempt to save a new version of a document located at /P/D where P is the directory path and D is the filename. An automatic versioning agent can then detect, for example, the file rename event that occurs when the original file is renamed according to the “delete/write file” method outlined above. Upon detecting a file system event which is a first component of a file versioning event at step 150 and identifying the file system event as a such at step 152, the automatic versioning agent proceeds to create a hard link at step 154 to the file system location where the original document /P/D was stored. The hard link indicates a version relationship between the original file and the updated version. For example, the hard link might have a unique path “/P/D/time/D” that indicates a version relationship between the original document (whose original filename was “P/D”) and its new version (which now bears the filename “P/D”).

Although the foregoing example mentions that a hard link can indicate a version relationship between the updated version and the original document using a path and filename which are derived from the path and filename of the original document, it should be appreciated that other means of achieving this indication are possible. For example, characteristics of a hard link other than file storage location identifier can be used to encode version relationship information, the number of these characteristics being limited only by the nature of the file system to which the present invention is applied. For example, information about the version relationship between the hard link, the updated file, and the original file can be stored in a versioning history database, and the hard link can have a file storage location identifier which corresponds to an entry in the versioning history database. Further, as previously mentioned, the format of a hard link can be extended or modified to allow hard links to incorporate additional information enabling the storage of versioning-related information.

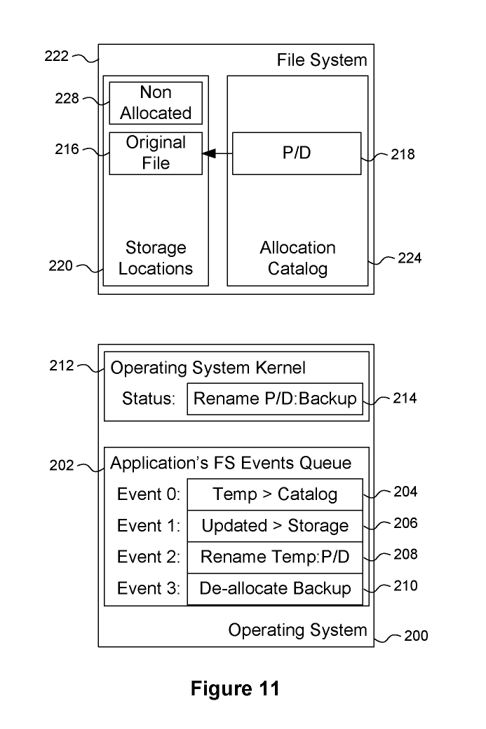

FIGS. 11-17 illustrate a sequence of file system component events making up a file versioning event. An originally intended sequence of file system events is altered by a method according to an embodiment of the invention to include a hard linking event prior to the execution of a final component of the file versioning event. In the final component, the original file storage location identifier is scheduled to be disassociated from the original storage location of the original file.

FIG. 11 is an illustration of a file system and operating system executing a file system event wherein a file is renamed. In this exemplary embodiment, the operating system 200 includes an application's file system (FS) events queue 202, which comprises a sequence of queued events 204, 206, 208 and 210. The queued events correspond to the 0^{th}, 1^{st}, 2^{nd} and 3^{rd} events queued to occur after the operating system kernel 212 has performed an event 214 that is currently being executed. A set of storage locations 220 are provided in file system 222, which also includes a file allocation catalog 224.

The file allocation catalog 224 contains catalog entries which comprise file storage location identifiers associated with storage locations within the set of storage locations 220. In the initial state illustrated in FIG. 11, the storage locations 220 include at least one non-allocated storage location 228 and a storage location of original file 216. The file allocation catalog 224 includes at least one original file storage location identifier 218 which is associated with the storage location of original file 216. This association is illustrated as an arrow pointing from original file system location identifier 218 to the storage location of original file 216.

As illustrated in FIG. 11, the event that is currently being executed is the first step in a sequence of component file system events that will comprise a file versioning event, if completed. By way of illustration, the first component event, illustrated in FIG. 11, is the renaming of original file system location identifier 218 from “P/D” to “Backup”. Those of skill in the art will appreciate that many types of file system events can be used by the automatic versioning system of the present invention in order to be able to identify a detected file system event as the first component event in a file versioning event. However, in this example it can serve as a suitable trigger for the detection step of a method embodying the present invention, such as the method illustrated in FIG. 9.

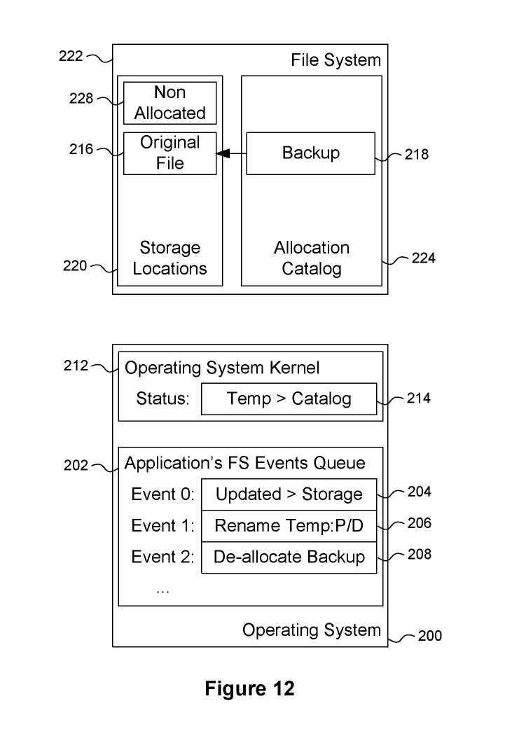

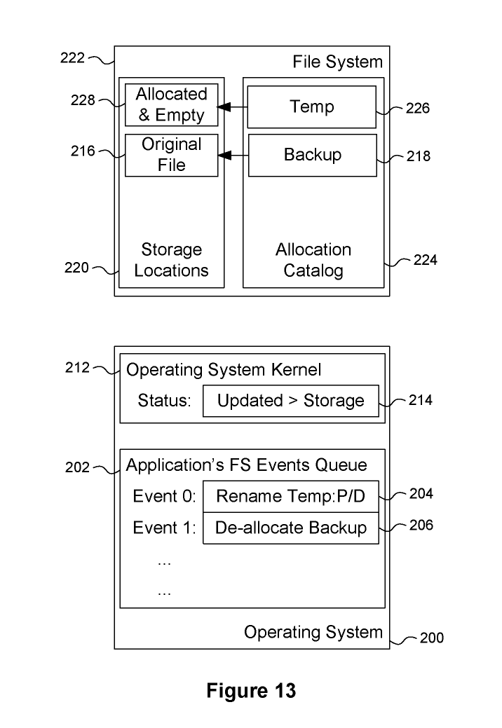

As can be seen in FIG. 12, after the component event processed in FIG. 11 was executed, each event in the queue from FIG. 11 has moved forward by one position. A similar process of advancing the application FS events queue 202 occurs between each of FIGS. 13-17.

In FIG. 12, the event 214 that is currently being executed is a file allocation operation that allocates non-allocated storage location 228 to a new file system location identifier in the allocation catalog 224 having the file name “Temp”.

In FIG. 13, the next component file system event to be processed in the sequence comprising the file versioning event is a write operation. The write operation writes the contents of the updated version of the original file to the at least one storage location 228 that has been associated with the file system location identifier element 226 named “Temp”, but is currently empty. The storage location of original file 216 is still associated with file system location identifier 218. The association between file allocation catalog element 226 and storage location 228 now associated with file allocation catalog element 226 is illustrated as an arrow pointing from file allocation catalog element 226 to storage location 228.

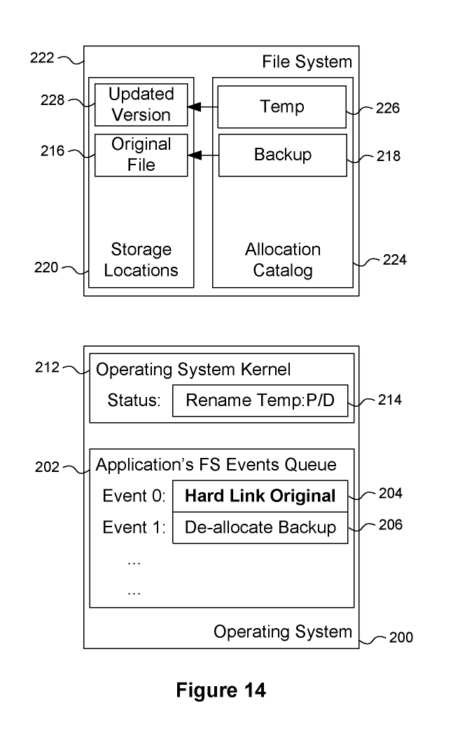

In FIG. 14, the automatic versioning system and method of the present invention has inserted a hard link event into the application's FS events queue 202 at the 0^{th} event position 204. This position in the application's FS events queue 202 is illustrated by way of example only. In an embodiment, the hard linking event shown in FIG. 14 can be inserted into the sequence of component file system events comprising the file versioning event at any time between the detection of the first component event in the file versioning event, and execution of a final component of the file versioning event. In the final component, the original file storage location identifier is scheduled to be disassociated from the original storage location of the original file.

It should also be understood that the hard linking event inserted into the application's FS events queue 202 in FIG. 14 need not be inserted into any queue associated with the application which initiated the file versioning event. The hard linking command can be passed to the operating system kernel 212 in any manner known to those of skill in the art so long as it enables the operating system kernel 212 to process the hard linking event prior to the disassociation of the original file storage location identifier 218 from the storage location of original file 216. The disassociation may be queued or otherwise scheduled by the application which initiated the file versioning event. As used herein, the term “scheduled” indicates only that the application initiating the file versioning event has invoked, is in the process of invoking, or plans to invoke, a means of ensuring that a particular event occurs at some future time.

In FIG. 14, the operating system kernel 212 executes a renaming event where file system location identifier 226 is renamed from “temp” to “P/D”, which was the original file name and path for original file system location identifier 218 associated with the storage location of original file 216, as illustrated in FIG. 11.

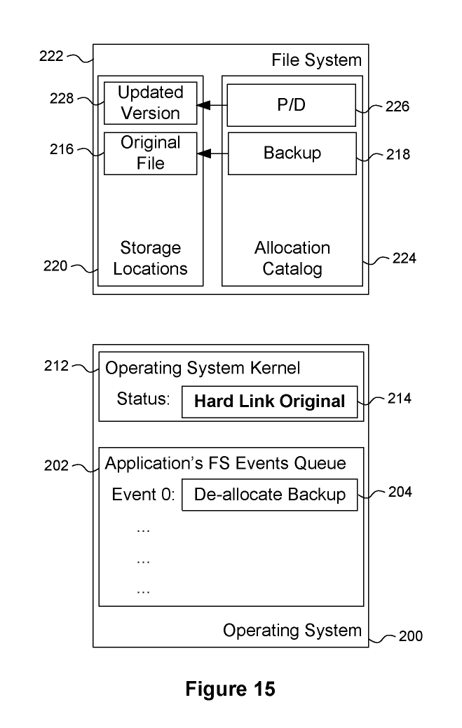

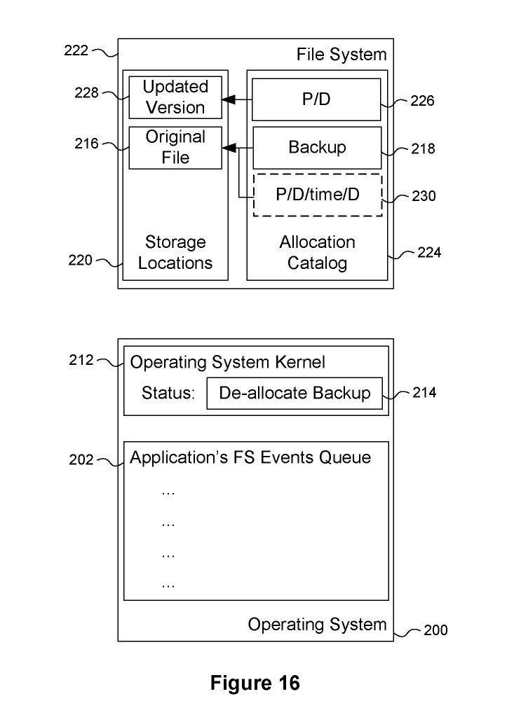

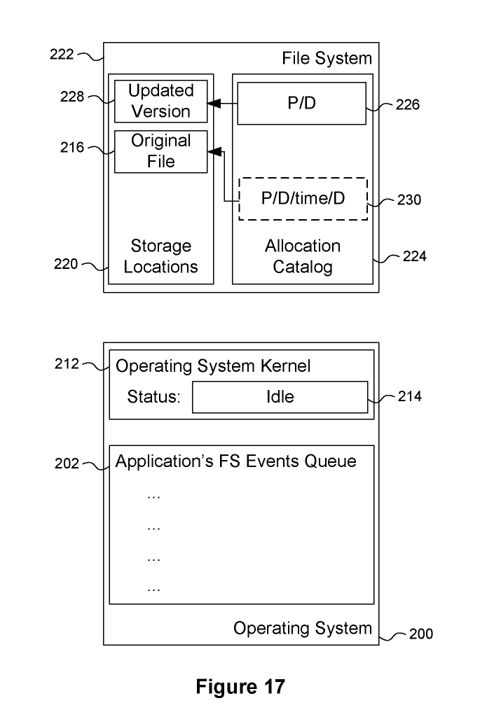

Turning to FIG. 15, the next component file system event to be processed in the sequence comprising the file versioning event is the hard link event. This event creates a hard link file allocation catalog element 230 (illustrated in FIGS. 16-17) which is linked to the storage location of original file 216.

The hard link file allocation catalog element 230 created in FIG. 15 is illustrated in FIGS. 16-17 as a box having a dashed outline to emphasize the difference between its nature and that of, say, a file system location identifier comprising a traditional path and filename associated with a physical storage location. Although the hard link file allocation catalog element 230 has the appearance of a file to user, it is simply a file system location identifier (in this example, “P/D/time/D”) and an association between that file system location identifier and a physical storage location, which is the storage location of original file 216 in this example. The exemplary hard link file allocation catalog element 230 has a path and filename “P/D/time/D” which indicates a relationship to the original file “P/D” (which name has at this point been given to file system location identifier element 226) and which also includes a timestamp associated with the time at which the file versioning event occurred. Of course, information other than the path and filename of the original file, or the time at which the version was created can also be stored in the hard link's file system location identifier 230.

FIG. 17 represents the return of the system illustrated in FIGS. 11-17 to an idle state, following execution of the final component event in the file versioning event of FIGS. 11-16, as indicated by the fact that original file storage location identifier 218 (not shown in FIG. 17) has now been disassociated from the storage location of original file 216.

Although the application's FS events queue 202 illustrated in FIGS. 11-17 is one example of a source of information which allows a method according to an embodiment of the present invention to identify and respond to file versioning events before their completion, it should be appreciated that the application's FS Events queue is not required for an embodiment of the method of the present invention to be implemented. Embodiments of the present invention can be co-implemented with any means of processing a file versioning event so long as it is possible to identify a first component of the file versioning event, and to execute a hard linking operation prior to the execution of a final file versioning component event wherein a file storage location identifier associated with an original file is scheduled to be dissociated from the storage location for that original file. Accordingly, it should be understood that embodiments of the present invention can be both application-independent as well as file-format-independent. For example, neither the nature of the application initiating the file versioning event nor the file formats used in the file versioning event need affect the operation of embodiments of the present invention. Embodiments of the present invention can be constructed which are not application or file-format independent, if so desired.

According to embodiments of the present invention, multiple versions of the same document can be saved using the method described above. An example of a set of hard link file storage location identifiers, comprising nested paths which incorporate information about the file name and path of the current version of a document, is provided below. In the example below, the five path and filename combinations correspond five versions of a document (including the current version):

| | |
|---|---|
| /P/D | current document hard |
| | linked to V4 |
| /P/D/backup/April_7_2007_1315/D | V4 - current version |
| | of document |
| /P/D/backup/April_6_2007_0917/D | V3 - |
| /P/D/backup/April_1_2007_1147/D | V2 - |
| /P/D/backup/March_31_2007_1600/D | V1 - original version |
| | of document |

As will be appreciated in view of the foregoing example, the versioning relationships indicated by the hard links created by embodiments of the present invention enable the creation of a version history for any given file, which can be arranged as an ordered collection of versions. By way of example, the version history can be reconstructed ex-post facto by scanning a file system for hard links generated according to embodiments of the present invention and analyzing their file names. A version history can also be constructed in real-time as an embodiment of the present invention is creating each hard link, or it can be constructed using some combination of ex-post-facto and real-time versioning analysis steps, so long as the versioning relationships between files can be determined.

A version history can be stored using in any known storage means, including databases, and can be used as a stepping stone to expanding upon the utility of the embodiments of the present invention. For example, a version history can enable the implementation of a versioning browser that allows users to visualize the versioning relationship of different versions of a file, or enable the implementation of a workflow versioning browser that allows users to visualize the workflow versioning relationships of different versions of multiple interrelated files within a workflow context. Such applications of a versioning history generated according to an embodiment of the present invention are described in the inventors' co-filed applications entitled “Method and Apparatus for Workflow Versioning”; U.S. application Ser. No. ______ (Attorney Docket No.: PAT 4299-2) entitled “Automatic Workflow Versioning” and filed of even date herewith; and U.S. application Ser. No. ______ (Attorney Docket No.: PAT 4297-2) entitled “Asset Browser for Computing Environment” and filed of even date herewith.

File versioning utilizing hard links according to embodiments of the present invention is very efficient in terms of time. There is no copying of large datasets, only the creation of some directory entries. The cost as with all versioning systems is in terms of storage space, however, those of skill in the art will appreciated that the storage space requirements of the present invention are minimal.

This approach to file versioning is applicable to a large number of modern operating system environments and modern file systems. No changes to the application programs people use for document creation and editing are required. To get the versioning benefits, the user does not have to take explicit action to cause versions to be saved thus they do not have to change current behaviour to utilize the invention. Effectively, the steps of detecting, identifying and creating inherent in the process can be performed transparently without input from a user.

Exemplary embodiments of the invention can therefore be run as background processes, such as services in operating systems belonging to the Windows® family of operating systems, daemons in Unix or Mac OS X operating systems, or terminate-and-stay-resident programs in the DOS family of operating systems. Those of skill in the art will appreciate that various aspects of these embodiments can be embodied as separate background processes, a single background process, or some combination of background processes and processes which are available for user interaction in the event that the user wishes to observe the status of an embodiment of the invention while it is operating.

Embodiments of the present invention can be deployed across file systems which span both local and remote file systems. However, not every type of file system is capable of performing a hard linking operation, and therefore alternate procedures such as server-side-copy operations are an alternative. Because of this possibility, embodiments of the present invention deployed across multiple systems can employ a method to automatically, and transparently, add versioning capability to such a system, even it some of its local or remote components are incapable of performing hard linking operations.

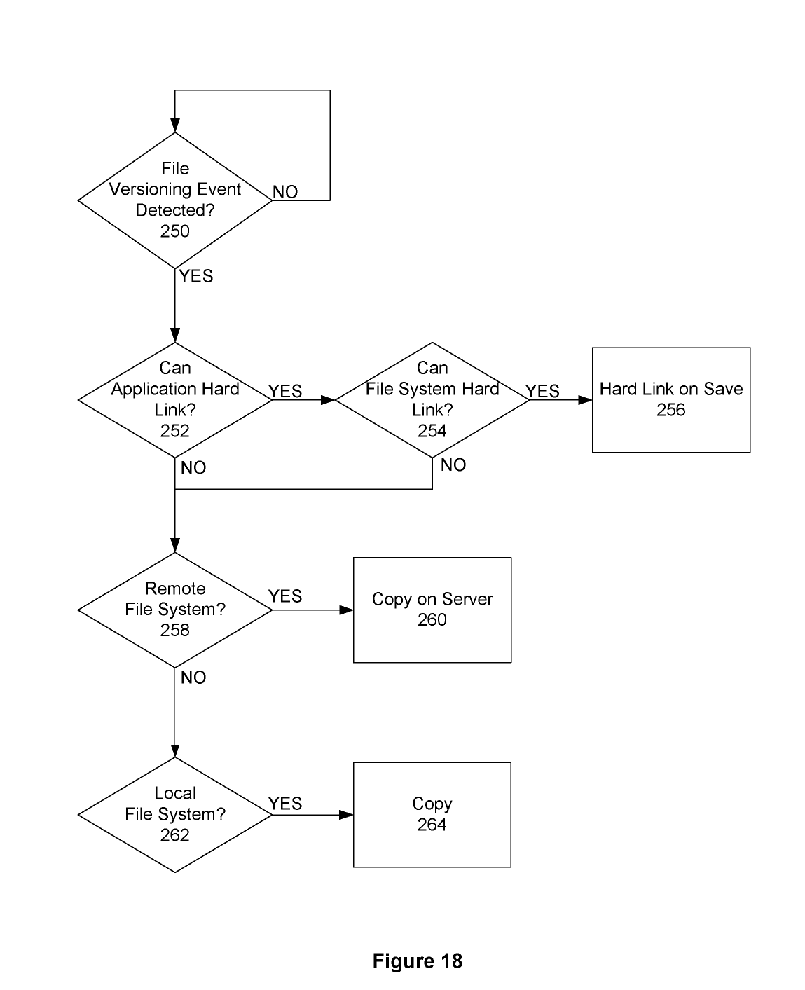

FIG. 18 is an illustration of a method of automatic file versioning according to an embodiment of the invention, the method being capable of accommodating various types of application and file system. The method of FIG. 18 begins at step 250 where a determination is made whether a file versioning event is detected. This step also encompasses the detection of the initiation of a file system event wherein an updated version of an original file stored at an original storage location is written to a new storage location. If no file versioning event is detected at step 250, the method continues to execute step 250 until a file versioning event is detected. When a file versioning event is detected at step 250, the method proceeds to step 252 where the method determines whether the application which initiated the file versioning event is capable of carrying out a hard linking operation.

If the method determines at step 252 that the application which initiated the file versioning event is capable of carrying out a hard linking operation, the method proceeds to step 254, where the method determines whether the file system can carry out a hard linking operation. A file system need not be a local file system to be able to carry out a hard linking operation—for example, Windows® Server Message Block (SMB) clients can perform hard linking on SMB-capable servers; other examples of remote file systems which can carry out hard linking are the Common Internet File System (CIFS) and Apple File Protocol (AFP). If the method determines that the file system can carry out a hard linking operation at step 254, the method proceeds to step 256, where a hard link is created to the original file, as described above with respect to the method illustrated in FIGS. 10-17.

If, at either of steps 252 or 254 the method determines that either the application or the file system cannot create a hard link to the original file, the method proceeds to step 258 where it determines whether the file system is a remote file system. If the method determines that the file system is a remote file system at step 258, the method proceeds to request a server-side copy operation at step 260, thus creating a backup version as is known in prior art versioning systems. Server-side copy operations reduce the number of file copy operations since a copy of the file does not need to be sent back and forth between the local file system from which the request originates during a server-side copying operation. If the method determines that the file system is not a remote file system at step 258, execution proceeds to step 262 where the method determines that the file system is a remote file system, in which case the method proceeds to make a standard copy of the original file at step 264, as is known in prior art versioning systems.

It should be appreciated that the exemplary method of FIG. 18 will generally be able to perform hard link operations when operating with modern file systems. However, by providing access to known methods of making local copies and server side copies of backup versions and providing a preferred hierarchy thereof, the method enables embodiments of the present invention to be backwards compatible. Even if deployed across large networks which include less modern software, or file systems which are incapable of employing hard links, embodiments of the present invention can seamlessly perform automatic versioning without placing large processing demands on the network.

Although embodiments of the present invention have been described as using hard links to co-opt known file overwriting processes into preserving previous versions of documents, it should be appreciated that file system entities other than hard link can be used to perform an equivalent function in embodiments of the present invention as long as they are capable of preventing the de-allocation of the storage location allocated to the original file. For example, an ordinary file allocation table entry such as a file storage location identifier can be used to preserve the address of the storage location at which an original file is physically located. Accordingly, as long as such a file system entity is created, the file system is effectively prevented from de-allocating the storage location allocated to the original file and making it available as free space. Further, when using ordinary file allocation table entries in this manner, it is possible to avoid creating a new file allocation table entry entirely by simply renaming the file allocation table entry for the original file so that it cannot be deleted by the final component event in a file versioning event.

While embodiments of the present invention have been described above in relation to “files” or “documents”, it is to be understood that these approaches also apply to other types of files, assets or data entities stored on computers, or on computer-readable media. Such assets or data entities can include, for example: applications; files; folders; fonts; effects; image layers; animation compositions; video tracks; and audio tracks.

In the above description, for purposes of explanation, numerous details have been set forth in order to provide a thorough understanding of the present invention. However, it will be apparent to one skilled in the art that these specific details are not required in order to practice the present invention. For example, specific details are not provided as to whether the embodiments of the invention described herein are implemented as a software routine, hardware circuit, firmware, or a combination thereof.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of automatic file versioning in a computing environment, comprising:
detecting initiation of a file system event wherein an updated version of an original file stored at an original storage location is written to a new storage location;
identifying the file system event as a first component of a file versioning event; and
creating a hard link to the original storage location, the hard link indicating a version relationship between the original file and the updated version,
the step of creating the hard link occurring prior to occurrence of a final component of the file versioning event wherein an original file storage location identifier is scheduled to be disassociated from the original storage location.

2. The method of claim 1 wherein the hard link includes a hard link storage location identifier derived from an updated file storage location identifier associated with the updated file, the hard link storage location identifier indicating the version relationship between the original file and the updated version.

3. The method of claim 2 wherein the hard link storage location identifier comprises a hard link directory path and file name derived from a directory path and file name associated with the updated file.

4. The method of claim 1 wherein the steps of detecting, identifying and creating are performed transparently without input from a user.

5. The method of claim 4 wherein the steps of detecting, identifying and creating are performed as background processes in the computing environment.

6. The method of claim 1 wherein performance of the steps of detecting, identifying and creating is application-independent having regard to an application associated with the file system event.

7. The method of claim 1 wherein performance of the steps of detecting, identifying and creating is file-format independent having regard to a file format associated with the file system event.

8. A system for automatic file versioning in a computing environment comprising:
a file system event monitor, in communication with a file system events engine, for detecting initiation of a file system event wherein an updated version of an original file stored at an original storage location is written to a new storage location, and for identifying the file system event as a first component of a file versioning event; and
a file versioner, in communication with the file system event monitor, for creating a hard link to the original storage location upon receipt of a communication from the file system event monitor indicating that the first component of the file versioning event has been identified, the hard link indicating a version relationship between the original file and the updated version,
wherein the file versioner creates the hard link prior to occurrence of a final component of the file versioning event wherein an original storage location identifier is scheduled to be disassociated from a file system location for the original file.

9. The system of claim 8 wherein the file versioner derives a hard link storage location identifier from an updated file storage location identifier associated with the updated file, the hard link storage location identifier indicating the version relationship between the original file and the updated version.

10. The system of claim 9 wherein the hard link storage location identifier comprises a directory path and file name derived from a directory path and file name associated with the updated file.

11. The system of claim 8 wherein the file system event monitor and the file versioner operate transparently without input from a user.

12. The system of claim 11 wherein the file system event monitor and file versioner operate as background processes in the computing environment.

13. The system of claim 8 wherein operation of the file system event monitor and file versioner is application-independent having regard to an application associated with the file system event.

14. The system of claim 8 wherein operation of the file system event monitor and file versioner is file-format-independent having regard to a file format associated with the file system event.

15. The system of claim 8 further comprising a user preferences module for restricting the operation of the file versioner according to stored file versioning preferences.

16. A computer readable medium containing computer instructions which, when executed, cause a processor to perform a method of automatic file versioning, comprising:
instructions for detecting initiation of a file system event wherein an updated version of an original file stored at an original storage location is written to a new storage location;
instructions for identifying the file system event as a first component of a file versioning event; and
instructions for creating a hard link to the original storage location, the hard link indicating a version relationship between the original file and the updated version,
the instructions for creating the hard link ensuring that the hard link is created prior to occurrence of a final component of the file versioning event wherein an original file storage location identifier is scheduled to be disassociated from the original storage location.

17. The computer readable medium of claim 16 wherein the instructions for creating the hard link further comprise instructions for ensuring that the hard link is provided with a hard link storage location identifier derived from an updated file storage location identifier associated with the updated file, the hard link storage location identifier indicating the version relationship between the original file and the updated version.

18. The computer readable medium of claim 17 wherein the instructions for creating the hard link further comprise instructions for ensuring that the hard link is provided with a storage location identifier comprising a hard link directory path and file name derived from a directory path and file name associated with the updated file.

19. The computer readable medium of claim 18 further comprising instructions for ensuring that, when the instructions contained within the computer readable medium are executed, the instructions for detecting, identifying and creating are executed transparently without input from a user.

20. The computer readable medium of claim 19 further comprising instructions for ensuring that, when the instructions contained within the computer readable medium are executed, the instructions for detecting, identifying and creating are executed as background processes in the computing environment.

21. The computer readable medium of claim 16 wherein the instructions for detecting, identifying and creating are application-independent having regard to an application associated with the file system event.

22. The computer readable medium of claim 16 wherein the instructions for detecting, identifying and creating are file-format independent having regard to a file format associated with the file system event.

23. A method of automatic file versioning in a computing environment comprising:
detecting initiation by an application of a file system event in a file system wherein an updated version of an original file stored at an original storage location is written to a new storage location;
identifying the file system event as a first component of a file versioning event;
if the application can hard link and if the file system can hard link, creating a hard link to the original storage location prior to occurrence of a final component of the file versioning event wherein the original storage location is scheduled to be disassociated from a file system location for the original file, the hard link indicating a version relationship between the original file and the updated version;
if the file system is a remote file system and either one of the application and the file system cannot hard link, creating a server-side copy of the file; and
if the file system is a local file system and either the application cannot hard link or the file system cannot hard link, creating a copy of the file.

24. A method of automatic file versioning in a computing environment, comprising:
detecting initiation of a file system event wherein an updated version of an original file stored at an original storage location is written to a new storage location;
identifying the file system event as a first component of a file versioning event;
causing a new file storage location identifier to become associated with the original storage location, the new file storage location identifier indicating a version relationship between the original file and the updated version, and preventing the file system from de-allocating the original storage location,
the step of causing a new file storage location identifier to become associated with the original storage location occurring prior to occurrence of a final component of the file versioning event wherein an original file storage location identifier is scheduled to be disassociated from the original storage location.
